(19) United States
(12) Patent Application Publication
(10) Pub. No.: US 2018/0263838 A1
(43) Pub. Date: Sep. 20, 2018

(54) Knuggle

(71) Applicant: Matthew Walker Navy, Grapevine, TX (US)

(72) Inventor: Matthew Walker Navy, Grapevine, TX (US)

(21) Appl. No.: 15/461,826

(22) Filed: Mar. 17, 2017

(51) Int. Cl. A61G 99/00

(52) U.S. Cl. CPC A61G 99/00

(57) ABSTRACT

For many side sleepers, a common hindrance to getting a good night's rest has been the position of one's knees during repose. It's outright uncomfortable to have one's knee caps resting atop each other, and so one leg must be slightly in front of or behind the other to avoid this discomfort. A common solution involves sleeping with a pillow between one's legs, but pillows are often too bulky and the material lacks the ability to ‘breathe,’ resulting in uncomfortable temperature changes, and they never seem to stay in place! Introducing the Knuggle, a wearable brace for one's knee that provides cushioned support for the inner-thigh and knee area. The Knuggle is easy to remove, stays in place, and provides the perfect amount of support for one's sleeping preference, and with custom designs one can personalize their nightwear to match their own unique style.

### CROSS-REFERENCE TO RELATED APPLICATIONS

Not Applicable

### BACKGROUND OF THE INVENTION:

The Knuggle is a wrap-around brace intended for use for the leg and knee area of an individual to provide support for the knee during rest and to place one's body in a more natural and comfortable sleeping position.

### BRIEF SUMMARY OF THE INVENTION

The Knuggle functions as wearable cushioned support for the sides of an individual's knee, primarily for the purpose of rest and sleepwear. The Knuggle conveniently replaces the common remedy of a pillow between an individual's legs, which is often an inconvenient solution due to a pillow's bulkiness and common shifting of its position during rest. The Knuggle primarily provides support for the knee, and also serves to put one's body in a more natural and comfortable resting position.

### BRIEF DESCRIPTION OF THE SEVERAL VIEWS OF THE DRAWING

FIG. 1 This image provides a clean, textless layout of the Knuggle's design when laid out flat. It presents the Knuggle in three angles: Back View (FIG. 1A), Front View (FIG. 1B) and Side View (FIG. 1C).

FIG. 2 This image provides a detailed layout of the Knuggle's design when laid out flat. It presents the Knuggle in three angles: Back View (FIG. 2A), Front View (FIG. 2B) and Side View (FIG. 2C). Sections are properly described, and where necessary arrows point to the specific areas where the text description is offset.

FIG. 3 This image provides a side-view of the Knuggle while being worn for its intended purpose. Sections are properly described with straight, short-arrowed lines pointing to specific areas of the design. Additionally, construction details are provided at the top in plain text for the consideration of production of the design.

### DETAILED DESCRIPTION OF THE INVENTION

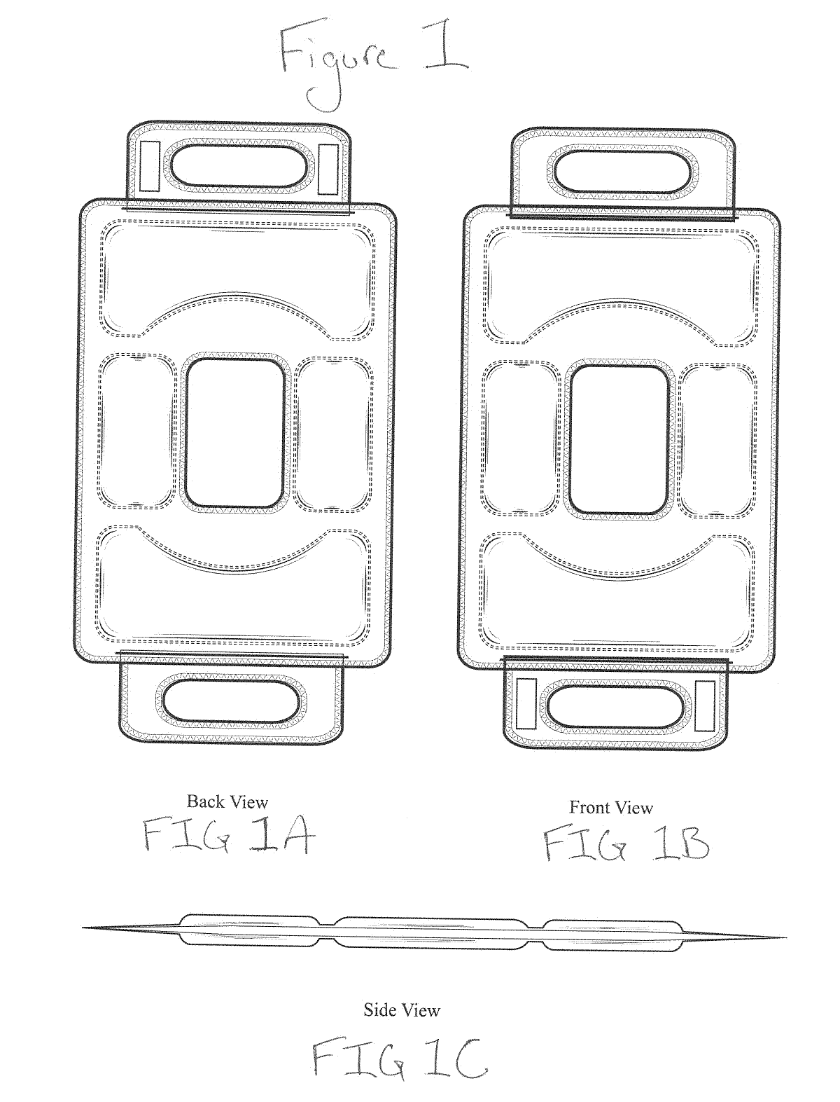

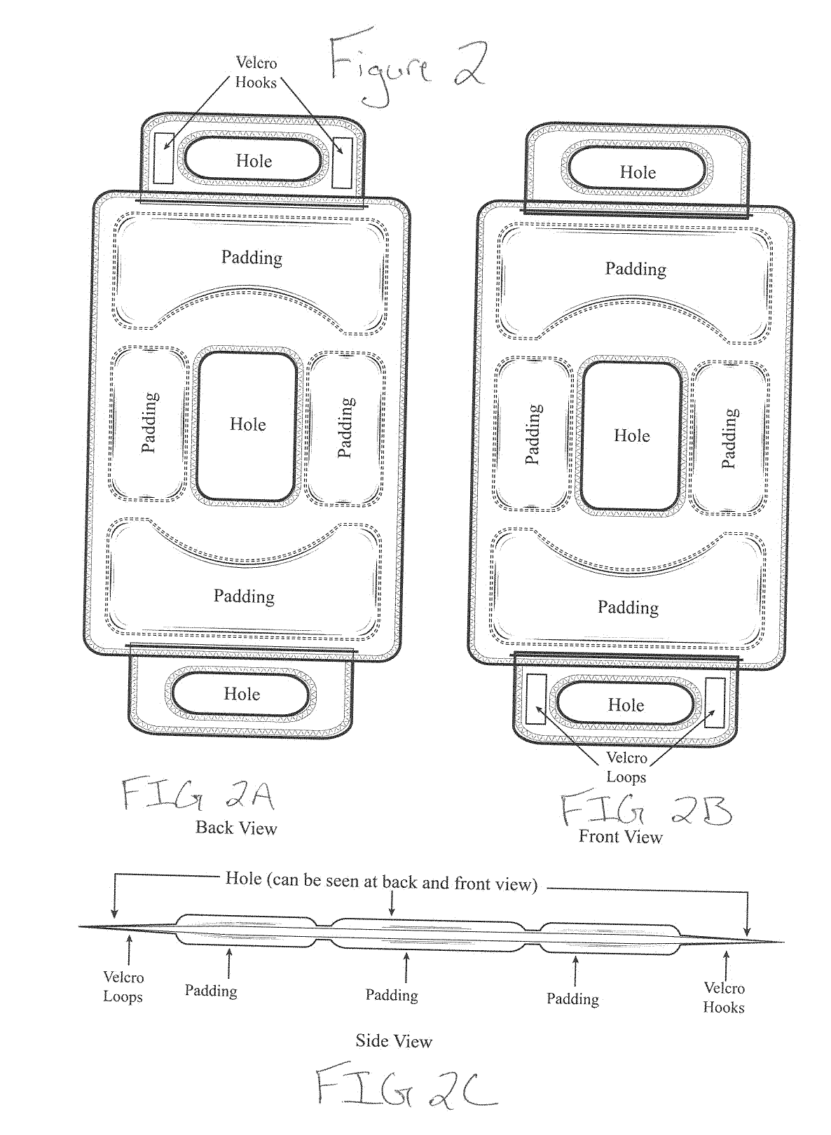

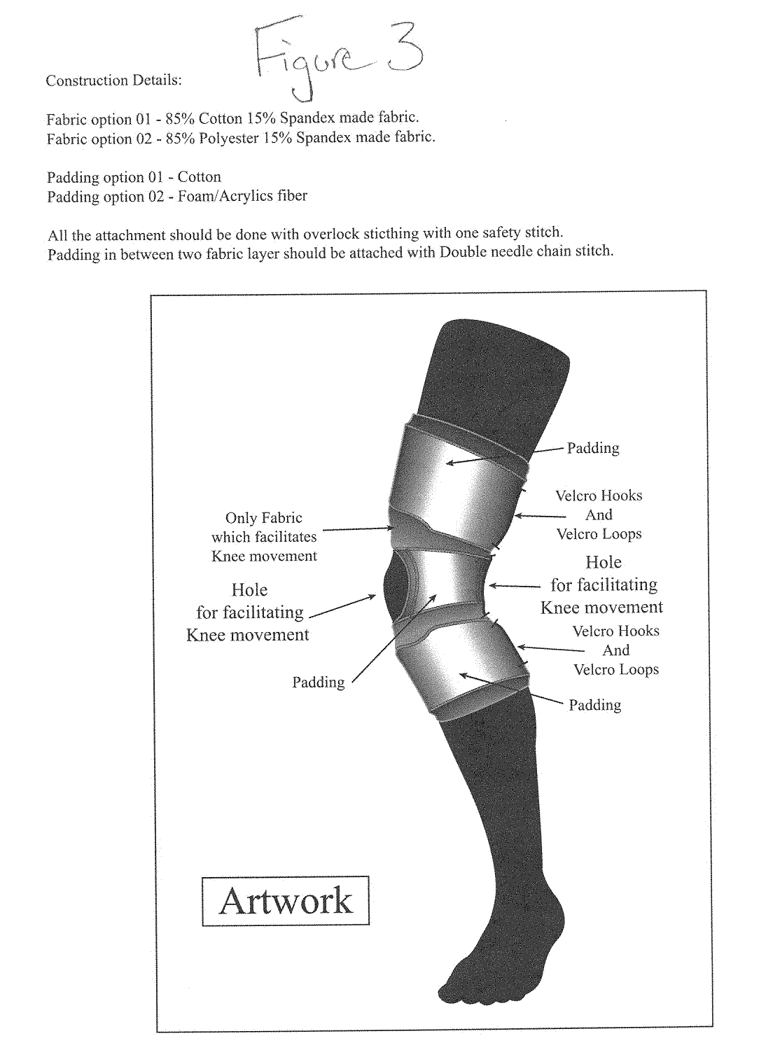

The Knuggle's design is comparable to a sports brace for the knee. The Knuggle can be quickly and easily removed through the use of velcro-like hooks and loops at each end, as shown in FIG. 2, and adhered at the back of the knee. A hole at the front of the knee facilitates free movement, and at the back of the knee there is an absence of cushioning to further facilitate movement of the leg to bend and contract without restriction, as shown in FIG. 3. The Knuggle is constructed of spandex-made fabric consisting of either cotton or polyester to allow the full-range of motion while wearing the Knuggle and to keep its position on one's leg. This material also allows the fabric to ‘breathe’ to reduce any discomfort due to temperature-related issues concerning wearable fabrics. The Knuggle's cushioning material consists of either cotton or foam/acrylics fiber, to provide proper cushioning at the inner-thigh area of the leg, which is its primary intent: to support an individual's knee area while laying on their side. These materials and their integration into the design are shown in FIGS. 1, 2 and 3. Additionally, the outer fabric of the Knuggle allows for the printing of custom designs, images and logos for the purpose of customization and marketing.

The Knuggle is unique in its function in that no other invention which provides cushioned support for the inside area of an individual's knee during rest utilizes a wrap-around brace design to achieve this purpose. Other inventions consist of two or more ‘pieces’ and do not address the convenience of the user through wearable, ‘breathable’ support. Additionally, because the outer fabric allows for the printing of custom designs, images and logos, the Knuggle can be personalized for its addition to any individual's wardrobe.

1. As the inventor I claim the invention herein referenced as the ‘knuggle’ is an original submission: I lay claim to the utilization of a wrap-around brace design in addressing the issue of ease-of-use in providing support for the inner-knee area during rest or relaxation. To my knowledge, no other invention utilizes this wrap-around brace design to achieve this primary purpose.
